(19) United States
(12) Patent Application Publication
(10) Pub. No.: US 2025/0083024 A1
(43) Pub. Date: Mar. 13, 2025

(54) WORKOUT SYSTEM

(71) Applicant: 9Round Franchising, LLC, Simpsonville, SC (US)

(72) Inventor: Lucas King, Greenville, SC (US)

(21) Appl. No.: 18/882,999

(22) Filed: Sep. 12, 2024

Related U.S. Application Data
(60) Provisional application No. 63/582,127, filed on Sep. 12, 2023.

(51) Int. Cl. A63B 71/06; H04L 67/51

(52) U.S. Cl. CPC A63B 71/0622; H04L 67/51; A63B 2071/0625; A63B 2225/20

(57) ABSTRACT

A workout system comprises an integration server, a voice timer system (VTS) desktop client, a daily workout screen (DWS) server, and a DWS software. The VTS desktop client is configured to transmit a post request to the integration server via an integration application programming interface. The DWS software is configured to poll the integration server for data and poll the DWS server for content updates. The integration server may be connected to a web portal that is configured to receive instructions from an administrator. The DWS server may be connected to the web portal and configured to receive instructions from the administrator.

### CROSS-REFERENCE TO RELATED APPLICATION

The present application claims priority to U.S. Provisional Patent Application No. 63/582, 127, filed Sep. 12, 2023, entitled “Workout System,” the entire contents of which are hereby incorporated by reference.

### FIELD OF INVENTION

The present invention relates generally to a workout system. More specifically, the invention relates to an improved and enhanced integration and syncing of audio and visual content for use with a workout system.

### BACKGROUND OF INVENTION

Many individuals workout to improve their physical and emotional well-being. Some users prefer to have different types of workouts so as to keep the workouts new, more stimulating, and to vary types of physical exercise. Additionally, during workouts, and particularly for new workouts, many individuals benefit from instruction on how to achieve certain moves and how to correctly do certain workouts. Some individuals prefer watching someone do workouts in order to learn how to do them. Others may prefer listening to someone explain how to do workouts in order to do them correctly. Some individuals may prefer both watching and listening to someone.

Typically, individuals go to workout facilities or watch instructional videos to learn new workouts. However, when individuals go to workout facilities, individuals may rely on in-person instruction. Even if an individual is watching instructional content that is delivered electronically, such systems may require an on-site worker dedicated to fixing and correcting errors in the delivery of such content. Further, the requirement to have an on-site worker may prevent workout facilities from being open during times which they may not otherwise be able to staff an on-site position.

### SUMMARY OF INVENTION

The present invention overcomes many of the shortcomings and limitations of the prior art devices discussed above. The invention described herein includes several embodiments of a workout system.

As discussed above, existing systems fail to address a need for constant and continuous syncing and integration of instructional content. The present invention overcomes these shortcomings by providing a system for syncing and integrating audio and visual content without requiring an on-site employee to correct issues. Rather, the system as provided herein may achieve such syncing and integration by continuously monitoring and correcting any identified issues.

The workout system provided herein may include: an integration server; a voice timer system (VTS) desktop client configured to transmit a post request to the integration server via an integration application programming interface; a daily workout screen (DWS) server; and a DWS software configured to poll the integration server for data and configured to poll the DWS server for content updates.

### BRIEF DESCRIPTION OF DRAWINGS

FIG. 1 is a workout facility according to an embodiment of the present invention.

FIG. 2 is a first workout system according to an embodiment of the present invention.

FIG. 3 is a second workout system according to an embodiment of the present invention.

While the disclosure is susceptible to various modifications and alternative forms, a specific embodiment thereof is shown by way of example in the drawings and will herein be described in detail. It should be understood, however, that the drawings and detailed description presented herein are not intended to limit the disclosure to the particular embodiment disclosed, but to the contrary, the intention is to cover all modifications, equivalents, and alternatives falling within the spirit and scope of the present disclosure as defined by the appended claims.

### DETAILED DESCRIPTION

The invention will now be described with reference to the drawing figures, in which like reference numerals refer to like parts throughout. For purposes of clarity in illustrating the characteristics of the present invention, proportional relationships of the elements have not necessarily been maintained in the drawing figures.

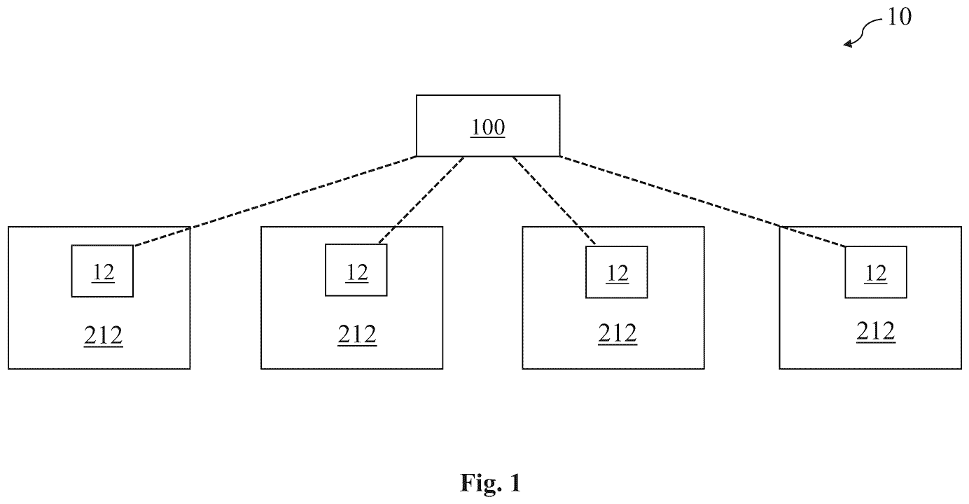

As shown in FIG. 1, a workout facility 10, such as a fitness studio or a home gym, may include a workout system 100. As discussed herein, the workout system 100 may provide instructional content management for content in the workout facility 10. The content may guide a user through one or more stations 212 located at the workout facility 10 using audio instructions synced with visual content on one or more screens 12. Each screen 12 may correspond to one or more of the stations 212 in the workout facility 10. The workout system 100 may be connected to screens 12 (as illustrated via dashed lines in FIG. 1) via a wired connection or a wireless connection. Each screen 12 may each be used to deliver the same or different content from each of the other screens 12. According to one embodiment, a workout facility comprises nine stations 212 and nine screens 12, wherein each screen 12 corresponds to one of the nine stations 212. Each screen 12 may be disposed proximate to (e.g., near or at) the corresponding station 212. In said embodiment, the workout system 100 is connected to the screens 12 and causes the screens 12 to display content to guide a user through the stations 212 at the workout facility 10. The user may complete one or more “circuits” through the stations 212.

In various embodiments, each station 212 may have workout equipment available for use. For example, the workout equipment may include one or more of dumbbells, medicine balls, kickboxing bags, speed bags, jump ropes, and so on. The stations 212 may each have different workout equipment, which may be specific to the content to be provided via the screen 12 corresponding to said station 212.

Each of the stations 212 may be associated with a workout session (referred to herein as a “session”). The screen 12 associated with each of the stations 212 may provide content specific to the session. For example, the screen 12 may provide content specific to a workout to be performed at the station 212 during the session and/or a break to be taken. The content may include, but is not limited to, details regarding the workout and/or break, instructions on performing the workout and/or break, instructions on use of workout equipment (which may or may not be present at the station), general conversation (such as words of encouragement), timers, countdowns, statistics, feedback, and so on. The screen 12 may provide content in any format, such as audio, visual, and/or audiovisual format.

In some embodiments, the screen 12 may provide content that instructs a user to perform a workout and then a break during a session. That is, in said embodiments, a session at a station 212 includes both a workout and a break. The break may be a rest break or an active break. The rest break may involve the user resting (e.g., ceasing to workout). The active break may involve the user performing one or more physical activities, such as jumping jacks, squats, burpees, and other movements. The screen 12 may provide content on the type of activity to be performed during the active break, which may be an activity that is the same as, similar to, or different from the activity performed during the workout. A user may perform the break (whether a rest break or an active break) at the station 212, beside the station 212, or away from the station 212. By way of example, in one embodiment, a plurality of stations 212 is disposed in proximity to each other, wherein each of the plurality of stations 212 is associated with a session comprising a workout and an active break. In said embodiment, the screen 12 associated with each station 212 will instruct the user to perform a workout and an active break. During the session, the user performs the workout at the station 212 and then performs the active break either at the station 212 or away from the station 212 (e.g., between stations 212). After the session is completed, the user moves to a different station 212 in the plurality of stations 212 and begins a different session associated with that station 212.

The session may be any duration of time in total length (e.g., less than 30 seconds, 30 seconds, one minute, two minutes, three minutes, four minutes, five minutes, more than five minutes, and any time between). In one embodiment, the session is approximately three and a half minutes in length. The session may be divided into any number of sections of time (e.g., 1, 2, 3, 4, or more sections of time). In one embodiment, the session is divided into three sections. The sections may be associated with a length of time in which a user should perform a workout or a break. That is, one workout session may be comprised of multiple sections, each of which correspond to whether the user should perform a workout or perform a break.

To illustrate the foregoing, in one embodiment, the workout session is approximately three and a half minutes in duration. The session is divided into three sequential sections, which are: (1) the first approximately two and a half minutes of the session, (2) the next approximately thirty seconds of the session, and (3) the final approximately thirty seconds of the session. These sections may be respectively titled (1) a workout duration, (2) a warning duration, and (3) an active break duration. That is, in said embodiment, the workout duration would begin at the start of the session (0 minutes) and end at approximately two and a half minutes into the session. The warning duration would begin at the end of the workout duration (e.g., at approximately two and a half minutes) and end at approximately three minutes into the session. The break duration would begin at the end of the warning duration (e.g., at approximately three minutes into the session) and end at approximately three and a half minutes, which is the end of the session.

In said embodiment, a user would perform a workout during both the workout duration and the warning duration of the session. The warning duration would signal to the user that the time for the active break will begin in approximately thirty seconds. Then, upon conclusion of the warning duration, the active break duration would commence, and the user would begin performing the active break. For ease of illustration, the embodiments described herein shall generally have a session comprising the aforementioned three durations. However, the names and time frames of these durations are for illustrative purposes and shall not be construed as limiting unless claimed as a feature.

The screen 12 at a station 212 may display a different color for each section of a session. For example, using the previously introduced time sections, the color green may be used for the workout duration (e.g., the approximate first two and a half minutes of the session), the color yellow may be used for the warning duration (e.g., the approximate thirty seconds from the two-and-a-half-minute mark to the three-minute mark), and the color red may be used for the active break duration (e.g., the approximate thirty seconds from the three-minute mark to the three-and-a-half-minute mark). The screen 12 may display a graphical interface that partially or fully features the color. In some embodiments, features on the screen 12 (such as images and/or text) of the graphical interface may appear in the color.

In some embodiments, the screen 12 at a station 212 may display one or more countdown timers. The one or more countdown timers may correspond to the total length of the session or to the individual section(s) of the session. For example, in one embodiment, the one or more countdown timers may correspond to the workout duration, the warning duration, and the active break duration. One countdown timer may run continuously through each section, or each section may have its own separate countdown timer. The countdown timer(s) may change colors throughout the session. In one embodiment, the color changes with each section in the session. For example, again using the previously introduced sections, the timer(s) may be displayed as green during the workout duration, yellow during the warning duration, and red during the active break duration. According to one embodiment, a user may know whether a workout station 212 can be used depending on the color of the timer(s) on the screen 12 at the station 212. For example, a station 212 may be joined when the timer is green, but not when the timer is yellow or red. If the timer is yellow or red, then a user may wait until the next session at the station 212 begins.

In one embodiment, the workout system 100 may cause the screen 12 to play audio(s) and/or display text(s) during the session. The audio(s) and/or text(s) may act as an alert regarding the status of the session (e.g., to denote the beginning or end of a session, to denote a change in section, etc.). The audio(s) and/or text(s) may be associated with the countdown timer(s). For example, in some embodiments, when the timer indicates that workout duration has commenced, the system 100 may be caused to simultaneously play audio to alert a user that the session has begun. In further embodiments, when the timer indicates that workout duration has ended, the system 100 may be caused to simultaneously play audio to alert a user that the warning duration (e.g., the final thirty seconds of workout) has commenced. The screen 12 may be caused to display text indicating the commencement of workout duration or the warning duration (e.g., “finale” or “thirty seconds”). When a predetermined time (e.g., three seconds) remains on the warning duration, the system 100 may be caused to play audio to alert a user that the predetermined warning time remains of the session (e.g., three seconds), and/or the screen 12 may be caused to display text indicating the predetermined warning time in text.

In some embodiments, after the warning duration elapses, the active break duration is caused to be displayed on the screen 12. During the entirety of the active break duration, a timer may be displayed on the screen 12 in a color (e.g., red) that is different from the color(s) of the timer(s), if any, displayed during the workout duration and the warning duration. The screen 12 may display text such as “ACTIVE BREAK.” When the active break duration commences, the workout system 100 may be caused to play an active break audio to alert the user of the commencement of the active break. The active break audio may be configured to alert the user of a type of exercise to be performed during the active break. The system 100 may cause the screen 12 to display a video file demonstrating the type of exercise to be performed during the active break duration.

Each screen 12 may be configured to play its associated session in a loop, with or without the presence of a user. In other embodiments, the session is activated by the presence of a user. For example, the user may manually initiate the session by engaging with the screen 12 (for example, by pressing a start or power button). Additionally, or alternatively, the system 100 may detect the presence of a user proximate to a station 212 (such as by motion sensing) and initiate the session at the station 212 in response.

The computer-readable executable instructions that cause the system 100 to display images or video or play audio may be stored on a memory of a computer at the station 212, stored remotely, in one computer file, and/or in multiple computer files.

To illustrate the foregoing, in one embodiment, the workout system 100 comprises a plurality of stations 212 (e.g., nine stations 212), wherein each station 212 contains a screen 12 and is associated with a workout session. The plurality of stations 212 may represent a “circuit” type workout, wherein a user is intended to visit each of the stations 212 in numerical order (e.g., 1, 2, 3, 4, 5, 6, 7, 8, 9) and complete the associated session. In said embodiment, each session may be approximately three and a half minutes in length and comprise a two-and-a-half minute (02 min:30sec) workout duration, a thirty second (00 min:30sec) warning duration, and a thirty second (00 min:30sec) active break duration. The screen 12 at each station 212 may display a countdown timer that corresponds to each of the three durations. The color of the countdown timer may change from green, to yellow, to red with the start of each duration. The screen 12 may contain content instructing the user as to the workout to perform at the station 212 during the workout duration and the warning duration. That is, while the countdown timer is green or yellow, the user may perform the workout indicated on or by the screen 12. When the user sees the timer change to red, the active break duration has begun, and the screen 12 may then display content instructing the user as to the activity to perform during the active break duration. The user may choose to perform the active break activity at or away from the stations 212. For example, the user may perform the active break between stations 212 in order to more easily move to the next station 212 at the conclusion of the active break duration. After completing a session, the user would then move to the next station 212 and complete the session associated with said next station 212 until visiting each station 212 in the workout facility 10.

Advantageously in some embodiments, the workout system 100 of the present disclosure is capable of automating the operation of the stations 212 simultaneously, such that more than one user may be present across the stations 212. By way of example, in embodiments having nine stations 212, a user may be at the first station 212, a user may be at a second station 212, a user may be at a fourth station 212, and a user may be at an eighth station 212. Embodiments of the workout system 100 can automate the sessions across the respective stations 212 with users synchronously such that each of the users transition between durations simultaneously or near simultaneously and likewise move between consecutively numbered stations 212 simultaneously as each user completes the active break duration. The workout system 100 may commence each session simultaneously or near simultaneously. The workout system 100 is particularly advantageous where it is desired to operate a workout facility 10 (such as a fitness center) 24/7 or “outside of business hours,” including when no employees of the facility 10 are onsite, as it solves a problem of how to synchronously change durations between multiple stations 212 in a way that can be automated.

According to various embodiments, the content on the workout system 100 (including but not limited to the content communicated via the screen at each station) may be updated on a desired schedule. The content may be updated automatically or manually. According to one embodiment, a workout system 100 may be updated automatically at a pre-determined, set time that may be most convenient for the workout facility 10 using such workout system 100 (e.g., late-night or early-morning hours). Advantageously, the workout system 100 of the present embodiments solves the technical problem of automated workout stations 212 that may become out-of-synchronization with each other.

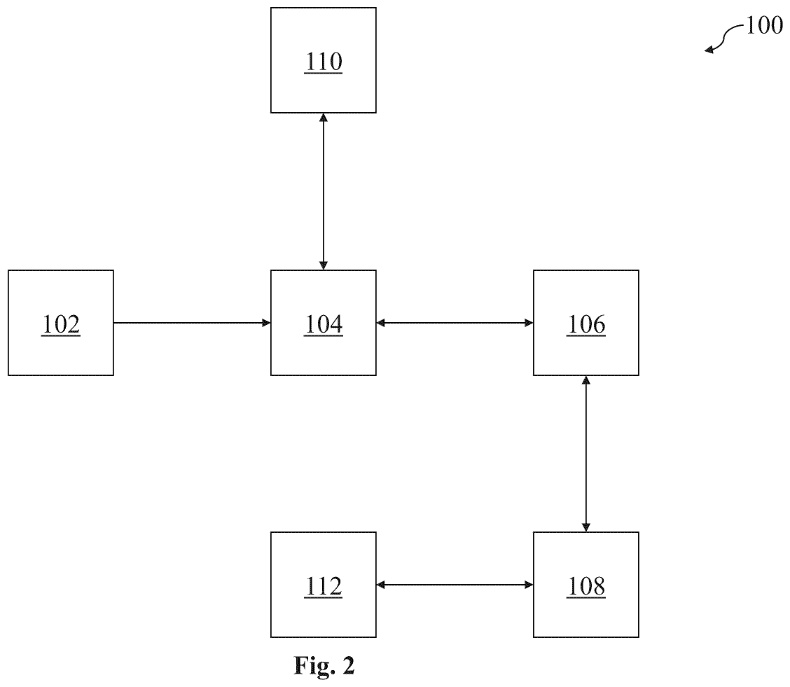

Turning now to FIG. 2, the workout system 100 may integrate between desktop software and cloud-based software. The workout system 100 may be of particular advantage for one or more workout facilities 10, such as fitness studios or home gyms. The desktop software may provide instructional audio content. The cloud-based software may provide visual content. The visual content may include a visual aid showing how workouts may be completed and may include an on-screen timer, which may display how much time is left in a particular workout. The audio content may include voice content explaining how workouts may be completed. The workout system 100 may integrate the audio content with the visual content, and the integrated content may be provided to any number of screens 12 that deliver the content. As used herein, “audio content” and “video content” may be referred to interchangeably with “audio file” and “video file,” respectively. Audio content and video content may be caused to be played and displayed simultaneously. According to one embodiment, the audio content may be visually reflected on the screen 12. As such, a user can listen to the audio content or read the audio content on the screen 12 (which may include the timer(s) for each session). Each of the screens 12 may be used to deliver different content, such that each screen 12 is used to deliver a certain portion of the content to the users (e.g., different sessions, each having a different workout). In some embodiments of the workout system 100, the components of the workout system 100 are able to send and receive communications with low latency (e.g., <200 milliseconds (“ms”), <100 ms, <80 ms, <50 ms, or <25 ms).

The workout system 100 may include a voice timer system (VTS) desktop client 102 which may transmit a post request to an integration server 104 via an integration application programming interface. The VTS desktop client 102 may be able to function with or without an internet connection, which may be desirable when the user prefers to work offline. However, an internet connection may be needed when the VTS desktop client 102 is first loaded, as the VTS desktop client 102 may verify that an associated license key is active and valid. The integration server 104 may store latency, time, content, and authentication data from the VTS desktop client 102.

The workout system 100 may include daily workout screen (DWS) software 106. The DWS software 106 may be associated with the content displayed on or by the screen 12 associated with each station 212. The DWS software 106 may poll the integration server 104 for new data, including for latency, time, and content updates. The DWS software 106 may poll the DWS server 108 for content updates. The DWS server 108 may store authentication, location, and content data, which the DWS software 106 may retrieve via polling. An internet connection may be needed when a user chooses to use the VTS desktop client 102 integration with the DWS software 106. In such a scenario, the VTS desktop client 102 may need to connect to an internet approximately every three-and-a-half minutes, as the VTS desktop client 102 may send latency data to aid in ensuring that the workout system 100 is synchronized. Once latency data history has been collected from the VTS desktop client 102, the workout system 100 may operate offline, as the VTS desktop client 102 may synchronize with the DWS software 106 using and based on the stored latency data history. In one embodiment, the content and information collected by the VTS desktop client 102 may be built into a binary executable format, such that the content and information may be executed without third-party streaming services. The VTS desktop client 102 may be updated to include new or updated content (e.g., new workouts at the station(s) 212, including new audio/visual files, such as updated instructor workout instructions the station(s) 212), and an internet connection may be necessary to download the updates to the local VTS desktop client 102.

According to various embodiments, the integration server 104 may be connected to an administrator integration web portal 110. Using the web portal 110, an administrator can create, activate, deactivate, and update VTS license keys. The VTS license keys may be managed by administrators and may be used to ensure that certain users are accessing and controlling the workout system 100 from particular screens 12. Administrators may utilize the web portal 110 to repair connections if the workout system 100 is experiencing issues. A “repair connection” button may be used when the audio file is playing. When the button is pressed, the screens 12 may be refreshed while the audio remains playing. When refreshed, the screens 12 may be cleared, removing the historical latency data and requiring the associated VTS desktop client 102 to use the freshest data available. Such a refresh may cause the VTS desktop client 102 to rebuild its latency data model and to re-initialize the timer algorithm using the most up-to-date data. According to various embodiments, the DWS server 108 may be connected to a DWS web portal 112. Using the web portal 112, administrators may manage content, locations, users, screens 12, screen links, and screen authorization. Using the web portal 112, users may manage such users' screens 12 at their locations (including the stations 212 and during their sessions).

The workout system 100 may be integrated and synced (synchronized) using the process and system as described herein. The aforementioned components may be used together in order to achieve the syncing function described herein. Each of the components may provide a unique feature or functionality to complete the syncing function. The syncing function may be completed at any time during a session at a station 212. The syncing function may rely upon the timestamp data from the VTS desktop client 102 and the UNIX time, which may cause all devices to sync at the same time. The following example may be used to illustrate how the workout system 100 may be integrated and synced; however, the following example is for illustrative purposes only and shall not be construed as limiting.

The integration and syncing process may begin when a user presses a “play button” on the VTS desktop client 102. The VTS desktop client 102 may transmit a timestamp to the integration server 104. Such timestamp may be representative of the number of milliseconds that have occurred since the “Epoch” (defined as midnight UTC at the beginning of Jan. 1, 1970). The VTS desktop client 102 may transmit to the integration server 104 a list of the breaks that have been shuttled using a randomizer associated with the VTS. The integration server 104 may store these timestamps and other key data. The key data may include a shuffled list of active breaks, an identification number associated with the station 212 being accessed, and a license key number.

The DWS software 106 may poll the integration server 104 in intervals, such as intervals of ten, twenty, thirty, forty, fifty, or sixty seconds. The intervals may be any number of seconds, and the foregoing examples shall not be construed as limiting. When the DWS software 106 receives the timestamp and associated data from the integration server 104, the DWS software 106 may begin the syncing process. The DWS software 106 may perform certain mathematical calculations to determine system latency associated with the VTS desktop client 102, as well as audio and network latency. The DWS software 106 may use the determined system latency to determine a real-time timestamp of a session (e.g., the real time point of a user in the three-minute-and-thirty-second session). For example, the DWS software 106 may determine that a user is at 02 min:36seconds of a 03 min:30seconds session based on the determined system latency. The DWS software 106 may render a countdown timer based on the final processed number calculated by the DWS software 106, and the workout system 100 may cause the countdown timer to be displayed on the screen 12. Advantageously, the rendered countdown timer may be synchronized to the playback of the audio and visual files. The following examples may be used to describe mathematical calculations as discussed above; however, the following examples are for illustrative purposes only and shall not be construed as limiting.

As a first example, the DWS software 106 may poll the integration server 104 every thirty seconds. In this example, one should assume that the screens 12 are turned “on” when the user presses the “play” button. In this example, the following variables have the following values: PR (polling rate)=30000 ms; C1=3:00 timer (180000 ms); C2=0:30 timer (30000 ms); X (length of the audio file)=C1 +C2=210000 ms; S1 (timestamp on the VTS desktop client 102)=1722629268038 ms; and S2 (timestamp on the DWS software 106)=1722629271041 ms. The following formulae are then calculated: T=S2−S1; Z=X−C2; B=X−T−Z; A=Z−C2; and Q=A+B. Given the aforementioned values, T=3003 ms, Z=180000 ms, B=26997 ms, A=150000 ms, and Q=176997 ms. In this example, with T being 3003 ms, it may take one iteration of the polling rate to establish a connection to the integration server 104 (approximately 3 seconds to connect all devices). The value of C1 may be rendered on a client countdown timer as “2:57,” and in such a scenario, the value would be 3 ms into the current shown second.

As a second example, the DWS software 106 may poll the integration server 104 for updates once every thirty seconds. In this example, one should assume that the screens 12 have not been turned “on” when the user presses the “play” button. In this example, one should also assume that the VTS desktop client 102 has been playing for more than one minute and that the user then powers the screens 12 “on.” In this example, the following variables have the following values: PR (polling rate)=30000 ms; C1=3:00 timer (180000 ms); C2=0:30 timer (30000 ms); X (length of the audio file)=C1 +C2=210000 ms; S1 (timestamp on the VTS desktop client 102)=1722627950395 ms; and S2 (timestamp on the DWS software 106)=1722628042880 ms. The formulae as set forth in the previous example are then calculated. Given the aforementioned values, T=92485 ms, Z=180000ms, B=-62485 ms, A=150000 ms, and Q=87515 ms. In this example, Q would equal 87515 ms, since the screens were not powered “on” when the “play” button was pressed. The value of C1 may be rendered on a client countdown timer as “1:28.”

In another example, one should assume that the VTS desktop client 102 is playing and that the screens 12 are powered “off” and then powered “on” again right before the active break. Given the polling rate, the workout system 100 would be rendering the C2 timer in the middle of the active break portion. In this example, the following variables have the following values: PR (polling rate)=30000 ms; C1=3:00 timer (180000 ms); C2=0:30 timer (30000 ms); X (length of the audio file)=C1 +C2=210000 ms; S1 (timestamp on the VTS desktop client 102)=1722626688091 ms; and S2 (timestamp on the DWS software 106)=1722626883746 ms. The formulae as set forth in the previous examples are then calculated. Given the aforementioned values, T=195655 ms, Z=180000 ms, B=-165655 ms, A=150000 ms, and Q=−15655 ms. In this example, Q is a negative number, because T has exceeded the amount of time of C1. If T is then subtracted from C1, that produces a negative number, and the system then adds in the next C variable (in this case C2). This addition of the next C variable would occur until the result of Q is a positive number. In this example, C1 +C2=210000 ms, and 210000-T=14345 ms. The value of C2 may be rendered on a client countdown timer as “0:14.”

The VTS desktop client 102 may transmit timestamps to the integration server 104 throughout its use, such as intervals of ten, twenty, thirty, forty, fifty, or sixty seconds. The intervals may be any number of seconds, and the foregoing examples shall not be construed as limiting. The DWS software 106 may then poll the integration server 104 for the timestamp data from the VTS desktop client 102. According to one embodiment, these transmissions and polling actions may occur at the end of each session, as discussed above. The DWS software 106 may process these timestamps and other data and calculate audio, network, and system latency to ensure that the audio file and timer are synced continuously.

As described herein, the workout system 100 may solve certain technical problems and issues currently present in existing systems. For example, delays may be caused when a user is performing other CPU/RAM-intensive tasks on the VTS desktop client 102 that is being used to provide the content to the workout system 100. This may result in delays in loading and playing audio files. To solve this issue, the workout system 100 provided herein includes custom algorithms to calculate audio, system, and network latency. Using the timestamp and other system data sent by the integration server 104 to the DWS software 106, the algorithms are used to calculate the precise position of the audio playback. An average, stable latency may be 20 ms to 40 ms. A high latency may be 200 ms to 400 ms. The latency may be added to each instance of a session in order to sync the audio and display files. In the event of a loss of internet connectivity, the algorithm provided herein may use an average calculated latency as the latency for syncing while offline.

The custom algorithms as described above may be used to recalibrate the workout system 100. As an example, assume that a workout facility 10 with the workout system 100 loses internet connection at 1:00 a.m. and that no personnel is scheduled to come to the facility 10 the next day. Even without a person present to “fix” the workout system 100, the custom algorithms may be utilized to correct the errors. The workout system 100 may have an administrator with enhanced privileges and access for controlling the workout system 100. The administrator may choose to enable a feature that will periodically check (e.g., every 3 hours, 1 hour, 30 minutes, 15 minutes, 5 minutes, 1 minute, 30 seconds, 15 seconds, 10 seconds, 5 seconds, 1 second) for critical failures in the workout system 100. If a failure is detected, then the screens 12 may attempt to refresh their states periodically up to and until the issue is resolved. If the workout system 100 cannot achieve internet connection (and thus, has been relying on the latency data saved in memory for a period that is pre-determined by the owner to be too long), then the timers may turn off temporarily. Upon detection of an active internet connection by the workout system 100, the timer functionality may resume operation. While the timer functionality remains inactive, all other functionalities of the workout system 100 will continue to operate as intended, as these functions do not rely on an active internet connection.

The administrator may choose to enable a feature under which, at a set time interval, the workout system 100 will automatically “hard refresh” its data. In such a scenario, the administrator may set a time interval of any time interval. As a non-limiting example, the time interval may be 6 hours. In such example, every 6 hours, the workout system 100 may refresh its state on each of the associated screens' 12 VTS desktop clients 102. Such a refresh may clear the historical latency data stored on the workout system 100, refresh the state of the VTS desktop clients 102, and re-initiate the initial synchronization algorithm. This may be advantageous in the event that the workout system 100, or a component thereof, becomes unstable, experiences hardware issues, and or otherwise fails to function as intended. Further, this may be useful for an owner who may want to ensure data freshness being used by the workout system 100.

The foregoing features may be enabled on a location-by-location basis by the administrator enabling such feature through an administrative selection screen, which may be displayed, for example, via a graphical user interface (GUI). Further, the administrators for a workout facility 10 (e.g., fitness studio) may access certain information through the administrative selection screen. As one example, the administrator may request real-time data to display the status of internet connection of the workout system 100 and the components thereof, and the administrator may cause the workout system 100 to transmit a notification (audio playback notification, graphical depiction on a display, or an electronic communication such as a text message or an e-mail) if an internet connection issue is identified. If an internet connection is identified, then the administrator may use the administrative selection screen to repair to cause the workout system 100 to refresh the state of the workout system 100 or any of its components.

Another technical problem solved by the instant embodiments is that, when timers run for extended periods of time, devices may become out of sync (e.g., due to network or hardware instability). As a solution of to this technical problem, alongside the aforementioned algorithms of the workout system 100, the user or the administrator of the workout system 100 may cause a refresh (or resynchronization) of the visual content and/or the timer on the displayed screens 12 independently from the playback of audio content. Beneficially, a user's workout is not interrupted while the audio playback continues during the refresh. The administrator may set a refresh to take place at set times or at set intervals. Periodic refreshing may be used to maintain the integrity of the connections of the screens 12 with the workout system 100 in case of network disruptions or unexpected hardware or software issues.

Yet another technical problem solved by the instant embodiments is synchronization issues across multiple screens 12. For example, in an out-of-synchronization system, each timer on each screen 12 may display a different timestamp. The embodiments of the workout system 100 solve this issue by causing the screens 12 to display the same number calculated from the VTS desktop client 102 latency and time data instead of accounting for latency based on an internal clock of a computer system running each screen 12. Using this solution, each of the screens 12 are in sync with the VTS desktop client 102 as well as in sync with each of the other screens 12 that are connected to the workout system 100.

If the administrator is alerted that screens are not functioning or the content is not syncing, the administrator may remote into the workout system 100 via the VTS desktop client 102 and activate (e.g., via selecting a GUI button) a connection repair, which may refresh every screen 12 of the workout system 100 and recalibrate the timers (all without stopping the audio content from playing). The connection repair feature may force a recalculation of the data, which may recalibrate the sync data and establish the connection the VTS desktop client 102. As stated, the audio content may continue to play during this connection repair, and once the refresh is complete, the timers may be synced to align with the audio content. Further, the administrator may refresh all or some of its screens 12, and each of the screens 12 may be remoted into and may be controlled internally. If a computer system running the VTS desktop client 102 shuts down due to power, network, or any other failure, the timer associated with the workout system 100 may continue to run. In such an instance, the screens 12 may have all of the collected data (e.g., images, video, latency history, metadata) stored that is needed for the screens 12 to operate. The data may be cached to the VTS desktop client 102, which allows the system to run if the absence of an internet connection. If latency data cannot be sent due to a lack of an internet connection, the DWS server 108 may use the stored data in memory to achieve synchronization across the devices. The DWS server 108 may be prompted that the updates on the VTS have ceased, and the latency may be calculated to zero. The workout system 100 will continue to run until new data is updated onto the integration server 104.

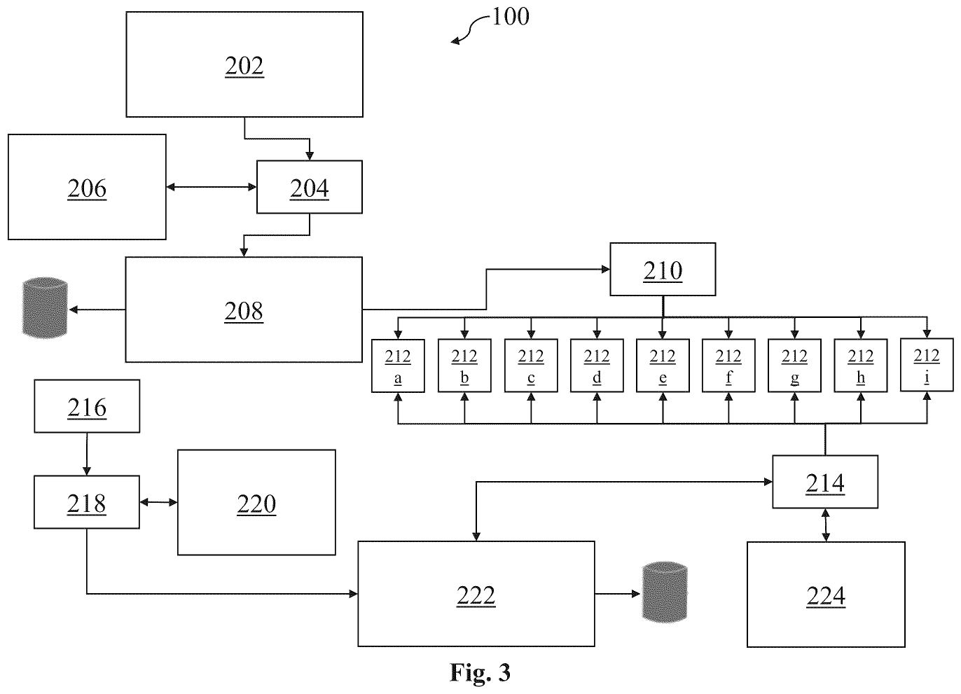

As used herein, the following numbered components may be the same as the numbered components in FIGS. 1 and 2. As illustrated in FIG. 3, a workout system 100 may include a VTS desktop client 202. The VTS desktop client 202 may be connected to an integration application programming interface (API) 204, which may be in communication with an administrator integration web portal 206. The integration API 204 may be in communication with an integration server 208, which may communicate with a second integration API 210. The integration API 210 may communicate with each screen 12 (not shown in FIG. 3) at the stations 212 (212a, 212b, 212c, 212d, 212e, 212f, 212g, 212h, and 212i).

The screens 12 at the stations 212 may be in communication with a DWS API 214, which may receive information and data ultimately from a single sign-on (SSO) portal 216. The SSO portal 216 may be connected to a second DWS API 218. The DWS API may be in communication with the DWS web portal 220. The second DWS API 218 may be connected to the DWS server 222, which may feed information to the first DWS API 214. The first DWS API 214 may receive further information from a DWS web portal 224.

As an example of use of the system 100 provided herein, the workout system 100 (such as via the VTS desktop client 202) may cause a GUI prompt to display a prompt at a screen 12 at a station 212 for a user to select stored content featuring a specific workout from one or more options. By way of example, the stored content may be considered a “play card” where the user may select from different instructors and/or different workouts. In some embodiments, the stored content of the play card contains one or more recordings featuring one or more instructors and/or workouts. The play card may contain content that features audio and/or visual recordings of humans and/or content that is wholly or partially generated by artificial intelligence (AI). For example, in some embodiments, the appearance and/or voice of the instructor may be that of an actual human, but the words and/or movements of the instructor are generated by AI. In some embodiments, the workout system 100 may cause different play cards to display at the station 212 and be accessible on different days, which may be associated with holidays or may be scheduled for a particular day (e.g., “Funday Monday” workouts).

The non-limiting embodiments described herein explain the principles of the inventions and their practical application so as to enable others skilled in the art to utilize the inventions and various embodiments and with various modifications as are suited to the particular use contemplated. Alternative embodiments will become apparent to those skilled in the art to which the present inventions pertain without departing from their spirit and scope. Accordingly, the scope of the present invention(s) is defined by the appended claims rather than the foregoing description and the exemplary embodiments described therein.

From the foregoing, it will be understood that various aspects of the processes described herein are software processes that execute on computer systems that form parts of the system 100. Accordingly, it will be understood that various embodiments of the system 100 described herein are generally implemented as specially-configured computers including various computer hardware components and, in many cases, significant additional features as compared to conventional or known computers, processes, or the like, as discussed in greater detail herein. Embodiments within the scope of the present disclosure also include computer-readable media for carrying or having computer-executable instructions or data structures stored thereon. Such computer-readable media can be any available media which can be accessed by a computer, or downloadable through communication networks. By way of example, and not limitation, such computer-readable media can comprise various forms of data storage devices or media such as RAM, ROM, flash memory, EEPROM, CD-ROM, DVD, or other optical disk storage, magnetic disk storage, solid state drives (SSDs) or other data storage devices, any type of removable non-volatile memories such as secure digital (SD), flash memory, memory stick, etc., or any other medium which can be used to carry or store computer program code in the form of computer-executable instructions or data structures and which can be accessed by a computer.

When information is transferred or provided over a network or another communications connection (either hardwired, wireless, or a combination of hardwired or wireless) to a computer, the computer properly views the connection as a computer-readable medium. Thus, any such a connection is properly termed and considered a computer-readable medium. Combinations of the above should also be included within the scope of computer-readable media. Computer-executable instructions comprise, for example, instructions and data which cause a computer to perform one specific function or a group of functions.

Those skilled in the art will understand the features and aspects of a suitable computing environment in which aspects of the disclosure may be implemented. Although not required, some of the embodiments of the claimed inventions may be described in the context of computer-executable instructions, such as program modules or engines, as described earlier, being executed by computers in networked environments. Such program modules are often reflected and illustrated by flow charts, sequence diagrams, exemplary screen displays, and other techniques used by those skilled in the art to communicate how to make and use such computer program modules. Generally, program modules include routines, programs, functions, objects, components, data structures, and API calls to other computers whether local or remote, etc. that perform particular tasks or implement particular defined data types, within the computer. Computer-executable instructions associated data structures and/or schemas, and program modules represent examples of the program code for executing steps of the methods disclosed herein. The particular sequence of such executable instructions or associated data structures represents examples of corresponding acts for implementing the functions described in such steps.

Those skilled in the art will also appreciate that the claimed and/or described systems 100 and methods may be practiced in network computing environments with many types of computer system configurations, including personal computers, smartphones, tablets, hand-held devices, multi-processor systems, microprocessor-based or programmable consumer electronics, networked PCs, minicomputers, mainframe computers, and the like. Embodiments of the claimed invention are practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

An exemplary system for implementing various aspects of the described operations, which is not illustrated, includes a computing device including a processing unit, a system memory, and a system bus that couples various system components including the system memory to the processing unit. The computer will typically include one or more data storage devices for reading data from and writing data to. The data storage devices provide nonvolatile storage of computer-executable instructions, data structures, program modules, and other data for the computer.

Computer program code that implements the functionality described herein typically comprises one or more program modules that may be stored on a data storage device. This program code, as is known to those skilled in the art, usually includes an operating system, one or more application programs, other program modules, and program data. A user may enter commands and information into the computer through keyboard, touch screen, pointing device, a script containing computer program code written in a scripting language or other input devices (not shown), such as a microphone, etc. These and other input devices are often connected to the processing unit through known electrical, optical, or wireless connections.

The computer that effects many aspects of the described processes will typically operate in a networked environment using logical connections to one or more remote computers or data sources, which are described further below. Remote computers may be another personal computer, a server, a router, a network PC, a peer device or other common network node, and typically include many or all of the elements described above relative to the main computer system in which the inventions are embodied. The logical connections between computers include a local area network (LAN), a wide area network (WAN), virtual networks (WAN or LAN), and wireless LANs (WLAN) that are presented here by way of example and not limitation. Such networking environments are commonplace in office-wide or enterprise-wide computer networks, intranets, and the Internet.

When used in a LAN or WLAN networking environment, a computer system implementing aspects of the invention is connected to the local network through a network interface or adapter. When used in a WAN or WLAN networking environment, the computer may include a modem, a wireless link, or other mechanisms for establishing communications over the wide area network, such as the Internet. In a networked environment, program modules depicted relative to the computer, or portions thereof, may be stored in a remote data storage device. It will be appreciated that the network connections described or shown are exemplary and other mechanisms of establishing communications over wide area networks or the Internet may be used.

While various aspects have been described in the context of a preferred embodiment, additional aspects, features, and methodologies of the claimed inventions will be readily discernible from the description herein, by those of ordinary skill in the art. Many embodiments and adaptations of the disclosure and claimed inventions other than those herein described, as well as many variations, modifications, and equivalent arrangements and methodologies, will be apparent from or reasonably suggested by the disclosure and the foregoing description thereof, without departing from the substance or scope of the claims. Furthermore, any sequence(s) and/or temporal order of steps of various processes described and claimed herein are those considered to be the best mode contemplated for carrying out the claimed inventions. It should also be understood that, although steps of various processes may be shown and described as being in a preferred sequence or temporal order, the steps of any such processes are not limited to being carried out in any particular sequence or order, absent a specific indication of such to achieve a particular intended result. In most cases, the steps of such processes may be carried out in a variety of different sequences and orders, while still falling within the scope of the claimed inventions. In addition, some steps may be carried out simultaneously, contemporaneously, or in synchronization with other steps.

The embodiments were chosen and described in order to explain the principles of the claimed inventions and their practical application so as to enable others skilled in the art to utilize the inventions and various embodiments and with various modifications as are suited to the particular use contemplated. Alternative embodiments will become apparent to those skilled in the art to which the claimed inventions pertain without departing from their spirit and scope. Accordingly, the scope of the claimed inventions is defined by the appended claims rather than the foregoing description and the exemplary embodiments described therein.

Any logic or application described herein may be implemented and structured in a variety of ways. For example, one or more applications described may be implemented as modules or components of a single application. Further, one or more applications described herein may be executed in shared or separate computing systems or a combination thereof. For example, more than one application may execute in the same computing system, or in multiple computing systems in the same computing environment. Additionally, it is understood that terms such as “application,” “service,” “system,” “engine,” “module,” and so on may be interchangeable and are not intended to be limiting.

Disjunctive language such as the phrase “at least one of X, Y, or Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

### LISTING OF EMBODIMENTS

Embodiment 1: A workout system, comprising:
an integration server;
a voice timer system (VTS) desktop client configured to transmit a post request to the integration server via an integration application programming interface;
a daily workout screen (DWS) server; and
a DWS software configured to poll the integration server for data and configured to poll the DWS server for content updates.

Embodiment 2: The workout system of embodiment 1, wherein the integration server is connected to a web portal.

Embodiment 3: The workout system of embodiment 2, wherein the web portal is configured to receive instructions from an administrator.

Embodiment 4: The workout system of embodiments 1-3, wherein the DWS server is connected to a web portal.

Embodiment 5: The workout system of embodiment 4, wherein the web portal is configured to receive instructions from an administrator.

Embodiment 6: The workout system of embodiments 1-5, wherein the workout system integrates at least one audio file with at least one visual file.

Embodiment 7: The workout system of embodiments 1-6, wherein the integration server stores at least one of latency data, time data, content data, and authentication data.

Embodiment 8: The workout system of embodiment 7, wherein the at least one of latency data, time data, content data, and authentication data is provided by the VTS desktop client. Embodiment 9: A method for syncing a workout system, comprising:
transmitting data from a voice timer system (VTS) desktop client to an integration server;
storing the transmitted data on the integration server;
polling, via the daily workout screen (DWS) server, for the data stored on the integration server;
calculating latency associated with the data; and
syncing the workout system based on the calculated latency.

Embodiment 10: The method of embodiment 9, wherein the integration server is connected to a web portal.

Embodiment 11: The method of embodiments 10, wherein the web portal is configured to receive instructions from an administrator.

Embodiment 12: The method of embodiments 9-11, wherein the DWS server is connected to a web portal.

Embodiment 13: The method of embodiment 12, wherein the web portal is configured to receive instructions from an administrator.

Embodiment 14: The method of embodiments 9-13, wherein the workout system integrates at least one audio file with at least one visual file.

Embodiment 15: The method of embodiments 9-14, wherein the integration server stores at least one of latency data, time data, content data, and authentication data.

Embodiment 16: The method of embodiment 15, wherein the at least one of latency data, time data, content data, and authentication data is provided by the VTS desktop client.

Embodiment 17: A workout system, comprising:
an integration server; and
a voice timer system (VTS) desktop client configured to transmit a post request to the integration server via an integration application programming interface.

Embodiment 18: The workout system of embodiment 17, further comprising:
a daily workout screen (DWS) server; and
a DWS software configured to poll the integration server for data and configured to poll the DWS server for content updates.

Embodiment 19: The workout system of embodiments 17-18, wherein the workout system integrates at least one audio file with at least one visual file.

Embodiment 20: The workout system of embodiments 17-19, wherein the integration server stores at least one of latency data, time data, content data, and authentication data.

Embodiment 21: A workout facility, comprising:
a plurality of stations;
a plurality of screens, each of the plurality of screens corresponding to one of the plurality of stations; and
a workout system connected to each of the plurality of screens, the workout system comprising:
   an integration server,
   a voice timer system (VTS) desktop client configured to transmit a post request to the integration server via an integration application programming interface,
   a daily workout screen (DWS) server, and
   a DWS software configured to poll the integration server for data and configured to poll the DWS server for content updates,
wherein the workout system causes content to be played on each of the plurality of screens.

Embodiment 22: The workout facility of embodiment 21, wherein each of the plurality of screens is associated with a workout session, and the content played on each of the plurality of screens is specific to the workout session.

Embodiment 23: The workout facility of embodiments 21-22, wherein each of the plurality of screens is associated with a different workout session.

Embodiment 24: The workout facility of embodiments 21-23, wherein the workout session comprises a workout duration, a warning duration, and an active break duration.

Embodiment 25: The workout facility of embodiments 21-24, wherein the content played on each of the plurality of screens includes one or more timers correlating to the workout duration, the warning duration, and the active break duration.

Embodiment 26: The workout facility of embodiments 21-25, wherein the one or more timers is green during the workout duration, yellow during the warning duration, and red during the active break duration.

Embodiment 27: The workout facility of embodiments 21-26, wherein the content played on each of the plurality of screens includes one or more workout instructions.

Embodiment 28: The workout facility of embodiments 21-27, wherein the content comprises an audio of a human voice providing the workout instruction.

Embodiment 29: The workout facility of embodiments 21-28, wherein the workout instruction comprises instructions to conduct a first physical activity during the workout duration and the warning duration and a second physical activity during the active break duration.

Embodiment 30: The workout facility of embodiments 21-29, wherein the workout duration is approximately two and a half minutes in length, the warning duration is approximately thirty seconds in length, and the active break duration is approximately thirty seconds in length.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

1. A workout system, comprising:
an integration server;
a voice timer system (VTS) desktop client configured to transmit a post request to the integration server via an integration application programming interface;
a daily workout screen (DWS) server; and
a DWS software configured to poll the integration server for data and configured to poll the DWS server for content updates.

2. The workout system of claim 1, wherein the integration server is connected to a web portal.

3. The workout system of claim 2, wherein the web portal is configured to receive instructions from an administrator.

4. The workout system of claim 1, wherein the DWS server is connected to a web portal.

5. The workout system of claim 4, wherein the web portal is configured to receive instructions from an administrator.

6. The workout system of claim 1, wherein the workout system integrates at least one audio file with at least one visual file.

7. The workout system of claim 1, wherein the integration server stores at least one of latency data, time data, content data, and authentication data.

8. The workout system of claim 7, wherein the at least one of latency data, time data, content data, and authentication data is provided by the VTS desktop client.

9. A method for syncing a workout system, comprising:
transmitting data from a voice timer system (VTS) desktop client to an integration server;
storing the transmitted data on the integration server;
polling, via the daily workout screen (DWS) server, for the data stored on the integration server;
calculating latency associated with the data; and
syncing the workout system based on the calculated latency.

10. The method of claim 9, wherein the integration server is connected to a web portal.

11. The method of claim 10, wherein the web portal is configured to receive instructions from an administrator.

12. The method of claim 9, wherein the DWS server is connected to a web portal.

13. The method of claim 12, wherein the web portal is configured to receive instructions from an administrator.

14. The method of claim 9, wherein the workout system integrates at least one audio file with at least one visual file.

15. The method of claim 9, wherein the integration server stores at least one of latency data, time data, content data, and authentication data.

16. The method of claim 15, wherein the at least one of latency data, time data, content data, and authentication data is provided by the VTS desktop client.

17. A workout system, comprising:
an integration server; and
a voice timer system (VTS) desktop client configured to transmit a post request to the integration server via an integration application programming interface.

18. The workout system of claim 17, further comprising:
a daily workout screen (DWS) server; and
a DWS software configured to poll the integration server for data and configured to poll the DWS server for content updates.

19. The workout system of claim 17, wherein the workout system integrates at least one audio file with at least one visual file.

20. The workout system of claim 17, wherein the integration server stores at least one of latency data, time data, content data, and authentication data.
